(19) United States
(12) Patent Application Publication
(10) Pub. No.: US 2014/0379198 A1
(43) Pub. Date: Dec. 25, 2014

(54) Mobile Object

(71) Applicants: Azusa Amino, Tokyo (JP); Ryosuke Nakamura, Tokyo (JP); Taishi Ueda, Tokyo (JP)

(72) Inventors: Azusa Amino, Tokyo (JP); Ryosuke Nakamura, Tokyo (JP); Taishi Ueda, Tokyo (JP)

(73) Assignee: Hitachi, Ltd., Chiyoda-ku, Tokyo (JP)

(21) Appl. No.: 14/364,495

(22) PCT Filed: Dec. 12, 2011
(86) PCT No.: PCT/JP2011/078729

§ 371 Date: Jun. 11, 2014

(51) Int. Cl. B62D 57/032; G05D 1/02

(52) U.S. Cl. CPC B62D 57/032; G05D 1/0231; Y10S 901/01; Y10S 901/47
USPC 701/28; 901/1; 901/47

(57) ABSTRACT

The present invention provides a mobile object capable of stable movement and jumping. The mobile object includes two moving means attached to left and right sides under a body; a sensor to detect attitude of the body; a controller to receive information from the sensor and perform calculation; two telescopic actuators attached between the body and the two moving means and configured to generate vertical forces; a rotary actuator provided at the center of the two telescopic actuators and configured to rotate around a moving direction of the body; a roll link connected with an output part of the rotary actuator; two suspensions connecting left and right ends of the roll link and the moving means; and foot frames attached between the suspensions and the moving means, wherein the controller controls the rotary actuator so that the sensor detects a target tilt angle and a target angular velocity of the body.

### TECHNICAL FIELD

The present invention relates to a mobile object including a body and a set of moving means on the left and the right as seen in the moving direction under the body, and further having a mechanism allowing jumping mounted thereon.

### BACKGROUND ART

A technology disclosed in PTL 1 provided below is known as an example of mobile objects capable of jumping in related art.

According to a method disclosed in PTL 1, a moving mechanism including swing arms on the left and the right of a mobile object is provided to allow jumping by releasing springs compressed by driving the swing arms.

### CITATION LIST

### Patent Literature

PTL 1: JP 2009-35157 A

### SUMMARY OF INVENTION

### Technical Problem

In the related art in PTL 1, only release of elastic energy stored in the spring is used as jumping means. Thus, an unexpected disturbance such as a step on a road surface or a change in the friction of the mechanism may cause variation in the expanding speed of the left and right springs depending on the balance of loads on the body, which may results in imbalance between left and right in jumping.

In other words, the mobile object may become out of balance at the body during jumping and fall when landing.

An object of the present invention is to provide a mobile object capable of suppressing imbalance between left and right of a body during moving or jumping caused by a disturbance such as an unexpected step or a slope on a road surface, which allows stable movement and jumping.

### Solution to Problem

To achieve the object, the present invention is directed to a mobile object including: two moving means attached to left and right sides under a body; a sensor configured to detect attitude of the body; a controller configured to receive information from the sensor and perform calculation; two telescopic actuators attached between the body and the two moving means and configured to generate vertical forces; a rotary actuator provided at the center of the two telescopic actuators and configured to rotate around a moving direction of the body; a roll link connected with an output part of the rotary actuator; two suspensions connecting left and right ends of the roll link and the moving means; and foot frames attached between the suspensions and the moving means, wherein the controller controls the rotary actuator so that the sensor detects a target tilt angle and a target angular velocity of the body.

To achieve the object, in the present invention, the moving means preferably each include a motor provided in the foot frame and a wheel driven by the motor.

To achieve the object, in the present invention, the telescopic actuators preferably each include a position detector.

To achieve the object, in the present invention, the sensor preferably detects a lateral tilt angle and an angular velocity of the body with respect to the direction of gravity.

To achieve the object, in the present invention, the controller preferably calculates a sum of a product of a difference between the lateral tilt angle and a lateral tilt angle target value and a predetermined positional gain and a product of a difference between the angular velocity and an angular velocity target value and a predetermined velocity gain, the sum being used as a control command value.

To achieve the object, in the present invention, the controller preferably outputs the control command value to the rotary actuator.

### Advantageous Effects of Invention

According to the present invention, a mobile object capable of suppressing imbalance between left and right of a body during moving or jumping caused by a disturbance such as an unexpected step or a slope on a road surface, which allows stable movement and jumping can be provided.

### BRIEF DESCRIPTION OF DRAWINGS

FIG. 1 is an overall configuration diagram of a mobile object according to the present invention.

FIG. 2 is a control block diagram of the mobile object according to the present invention.

FIG. 3 is a flowchart illustrating control of the mobile object according to the present invention.

FIGS. 4(a) to 4(d) are diagrams illustrating operation of the mobile object according to the present invention.

FIGS. 5(a) and 5(b) are diagrams illustrating operation of the mobile object according to the present invention.

### DESCRIPTION OF EMBODIMENTS

Embodiments of the present invention will be described below with reference to the drawings.

### First Embodiment

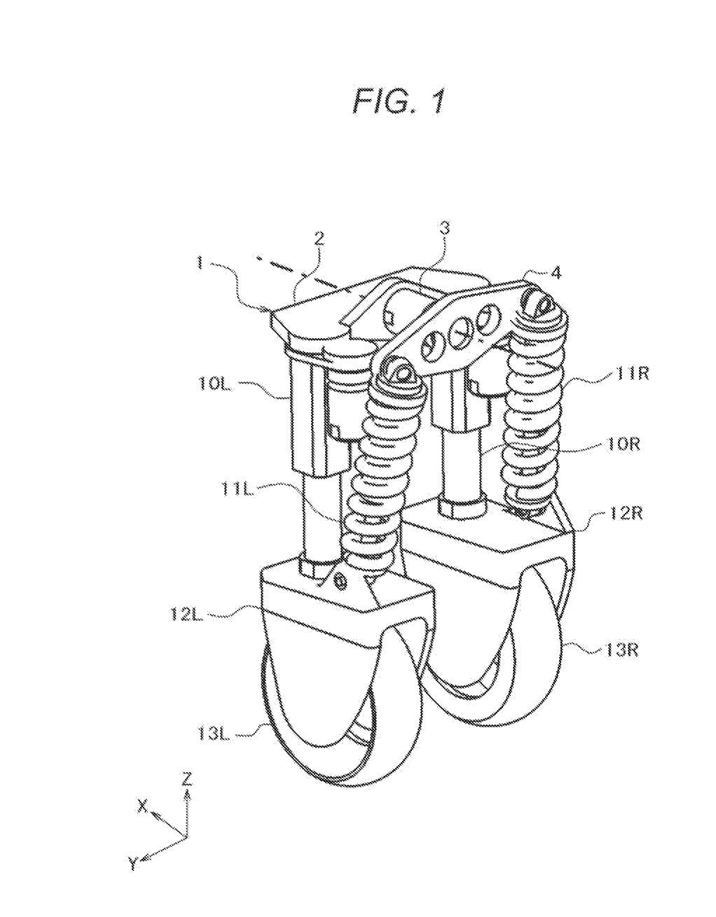

A configuration of a mobile object 1 according to the present embodiment will be described with reference to FIG. 1.

FIG. 1 is a view of the mobile object 1 seen from the upper-left rear with respect to the moving direction.

In FIG. 1, the moving direction of a robot 1 is represented by an X axis, the direction around the X axis is referred to as a roll direction, an axis perpendicular to the X axis and parallel to the horizontal plane in the moving direction is referred to as a Y axis, the direction around the Y axis is referred to as a pitch direction, an axis perpendicular to the X axis and the Y axis is referred to as Z axis, and the direction around the Z axis is referred to as a yaw direction, which are hereinafter used unless other special expressions are stated.

In FIG. 1, the mobile object 1 of the present embodiment includes a body 2 having a shape that is symmetric in the Y-axis direction, and telescopic actuators 10L and 10R that extend and compress in the Z direction and that are connected to left and right ends of the body 2, respectively. The other ends in the longitudinal direction of the telescopic actuators 10L and 10R are connected with foot frames 12L and 12R, respectively. The body 2 has attitude measuring means such as a gyroscope configured to measure the attitude of the mobile object and a controller configured to control respective parts of the mobile object on the basis of its attitude, which are mounted therein.

The telescopic actuators 10L and 10R are actuators capable of extending and retracting output ends in the extending direction or in the compressing direction, having a degree of freedom extending and compressing only in the Z direction, each including a power source (such as a hydraulic, pneumatic, or linear motor) and a position detector (such as a linear encoder), and configured no drive parts connected to the output ends. Furthermore, a rotary actuator 3 capable of swinging around the X axis is provided at the center of the body 2, and a roll link 4 having a shape with the longitudinal direction along the lateral direction of the rotary actuator 3 is connected with an output shaft of the rotary actuator 3.

The rotary actuator 3 is rotatable around the X axis, includes a power source (such as a motor), a speed reducer, and an angle detector (such as a rotary encoder or a potentiometer), and drives a part connected with the output shaft. The roll link 4 is connected at the center in the longitudinal direction with the output shaft of the rotary actuator 3, and is connected at both ends in the longitudinal direction with suspensions 11L and 11R with ball joints therebetween. The suspensions 11L and 11R are connected at ends opposite in the longitudinal direction to the ends connected with the roll link 4 with the foot frames 12L and 12R, respectively, with ball joints therebetween.

The spring constants of the suspensions 11L and 11R are determined so that loads applied on the telescopic actuators 10L and 10R become close to 0 at predetermined positions, and a small amount of energy is used to drive the telescopic actuators 10L and 10R during normal movement.

For ensuring roll stiffness, the suspensions 11L and 11R may be set so that a reaction force equal to or larger than the weight of the body 1 is generated and that the springs of the suspensions 11L and 11R are compressed only when excessive loads are input.

The foot frames 12L and 12R have wheels 13L and 13R, respectively, rotatable around the Y axis. The controller reads a value from the attitude measuring means provided in the body 2 and drives actuators for movement provided in the foot frames 12L and 12R, so that the wheels 13L and 13R are controlled. to maintain an inverted attitude.

Although moving means are constituted by the actuators for movement and the wheels 13L and 13R provided in the foot frames 12L and 12R herein, the moving means are not limited to those including wheels as long as the moving means allow movement on a road surface. Furthermore, although the telescopic actuators 10L and 10R are described as extending and compressing in the Z direction that is the driving direction of a hydraulic, pneumatic, or linear motor, or the like herein, the telescopic actuators 10L and 10R may generate a force in the Z direction with swing arms constituted by two-joint links, or may generate a force in the Z direction by releasing elastic energy by using springs provided therein, for example.

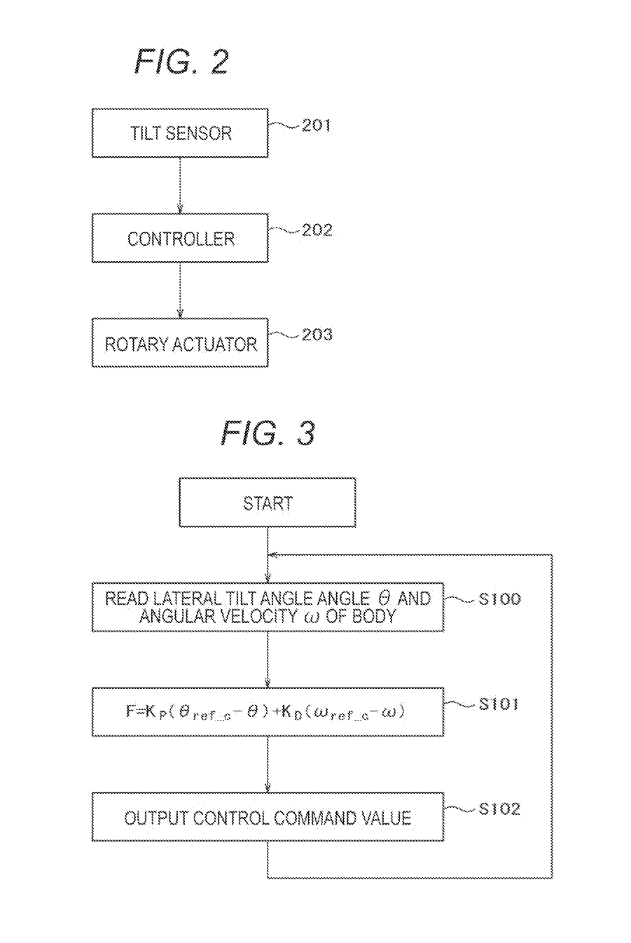

FIG. 2 is a control block diagram of the mobile object 1 according to the present invention.

In FIG. 2, when the mobile object 1 of FIG. 1 moves on an irregular road surface or a sloped road surface or receives a centrifugal force during cornering, vertical vibration of the mobile object 1 is reduced by the frictional resistances in the suspensions 11L and 11R and the telescopic actuators 10L and 10R. If the amounts of sinking of the left and right suspensions 11L and 11R are different, the upper body of the mobile object 1 tilts toward the side with the larger amount of sinking. If it is attempted to make the mobile object 1 recover from the tilt by using the telescopic actuators 10L and 10R, lateral rolling (rotational vibration around the X axis) is caused because the actuators 10L and 10R have relatively rough positional accuracy characteristics like air cylinders.

A tilt sensor 201 is mounted on the body 2 to detect a tilt angle and an angular velocity of the body 2 with respect to the direction of gravity, and the controller 202 properly controls the rotary actuator 203 so that the tilt and the angular velocity of the body 2 become equal to target values on the basis of detection information from the tilt sensor 201.

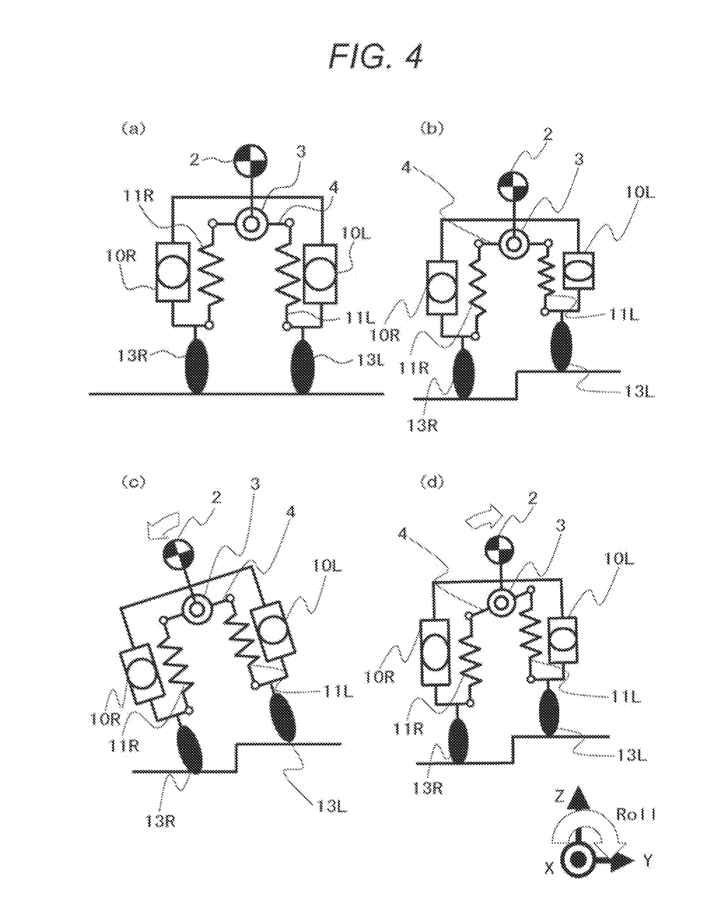

Next, operation of the mobile object 1 according to the present invention will be described with reference to FIGS. 3 and 4(a) to 4(d).

FIG. 3 is a flowchart illustrating control of the mobile object 1 according to the present invention.

Step 1: Detect the lateral tilt angle θ and the angular velocity ω of the body 2 with respect to the direction of gravity by the tilt sensor 201 mounted on the body 2 (S100).

Step 2: Calculate a sum of a product of a difference between the lateral tilt angle θ obtained in S100 and a lateral tilt angle target value θ_{ref}_{_{—}}_{c} and a predetermined positional gain Kₚ and a product of a difference between the angular velocity ω obtained in S100 and an angular velocity target value ω_{ref}_{_{—}}_{c} and a predetermined velocity gain K_{d}, which is used as a control command value F (S101).

Step 3: Output the control command value F calculated in S101 to the rotary actuator 3 (S102).

The steps 1 to 3 are performed at every predetermined sampling time ΔT.

Next, operation of the mobile object 1 going over a step will be described with reference to FIGS. 4(a) to 4(d).

FIG. 4(a) is a schematic diagram illustrating a state in which the mobile object 1 according to the present invention moves normally on a flat road surface. Herein, the mobile object 1 is moving from the back toward the front in the drawing. During the movement, the roll link 4 is subjected to loads from the suspensions 11L and 11R connected with the left and right ends, bus the driving force from she rotary actuator 3 for driving the roll link 4 is small because the left and right loads are balanced.

FIG. 4(b) is a diagram illustrating the mobile object 1 at a moment one wheel (the left wheel herein) of the mobile object 1 runs on a step. The impact force from the step is input to the wheel 13L, and then transmitted through the foot frame 12L, which is not illustrated here, to the telescopic actuator 10L and the suspension 11L in parallel. The telescopic actuator 10L and the suspension 11L are compressed to predetermined lengths to absorb the impact force from the road surface.

FIG. 4(c) is a diagram illustrating the mobile object 1 tilted after a lapse of certain time after one wheel ran on the step. The suspension 11L that has absorbed the impact from the step starts to extend again and tilts rightward.

FIG. 4(d) is a diagram illustrating the mobile object 1 having recovered from the tilt. When the mobile object 1 is tilted as in FIG. 4(c), the rotary actuator 3 is controlled to offset the tilt of the mobile object I as in the flowchart of FIG. 3. Specifically, the roll link 4 is rotated in the counterclockwise direction in the drawing so as to reduce the load on the suspension 11L and apply a load on the suspension 11R. In this manner, the mobile object recovers from the tilt and can move stably.

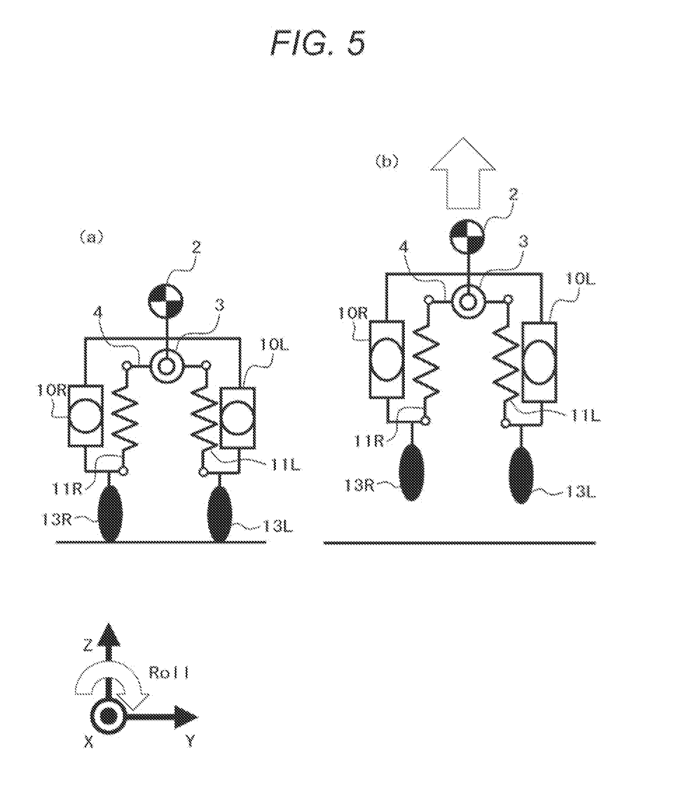

FIGS. 5(a) and 5(b) are diagrams for explaining jumping operation of the mobile object 1.

FIG. 5(a) illustrates a state of normal movement on a flat road surface. FIG. 5(b) is a diagram illustrating the mobile object 1 at a moment of jumping.

The mobile object 1 jumps by quickly extending the left and right telescopic actuators 11L and 11R. If the attitude of the mobile object 1 is off the target at the moment of jumping owing to the irregularity and the slope of the road surface, the rotary actuator 3 is controlled according to the control flowchart illustrated in FIG. 3 so that the attitude will recover.

As a result of using separate actuators for jumping and for maintaining the attitude in the roll direction in this manner, the mobile object 1 according to the present invention can use an actuator with relatively rough accuracy, placing priority on the speed, for the actuator used for jumping and an actuator with relatively lower speed, placing priority on the positional accuracy, for the actuator used for maintaining the attitude in the roll direction.

According to the present invention, as illustrated in FIG. 4(d), since the impact force from the step when the mobile object 1 comes to the step is transmitted to the telescopic actuator 10L and the suspension 11L in parallel, the telescopic actuator 10L and the suspension 11L can absorb the impact force from the road surface by being compressed to predetermined lengths.

Thus, according to the present invention, the mobile object can jump sideways by using the operation illustrated in FIG. 4(d) to lose the load balance on a flat surface without any step by itself and performing jumping operation as in FIG. 5(b) from this state. In other words, the mobile object can run up steps of stairs or the like by jumping sideways, for example. In this case, the mobile object is assumed to be capable of running up if the mobile object can jump to a maximum height of 240 mm taking typical heights of stairsteps into account.

As described above, according to the present invention, a mobile object capable of not only realizing stable movement and jumping but also running up stairsteps where appropriate can be provided.

### REFERENCE SIGNS LIST

1 mobile object

2 body

3 rotary actuator

4 roll link

5 mobile object

10L, 10R telescopic actuator

11L, 11R suspension

12L, 12R foot frame

13L, 13R wheel

201 tilt sensor

202 controller

203 rotary actuator

1. A mobile object comprising:
two moving means attached to left and right sides under a body;
a sensor configured to detect attitude of the body;
a controller configured to receive information from the sensor and perform calculation;
two telescopic actuators attached between the body and the two moving means and configured to generate vertical forces;
a rotary actuator provided at the center of the two telescopic actuators and configured to rotate around a moving direction of the body;
a roll link connected with an output part of the rotary actuator;
two suspensions connecting left and right ends of the roll link and the moving means; and
foot frames attached between the suspensions and the moving means, wherein
the controller controls the rotary actuator so that the sensor detects a target tilt angle and a target angular velocity of the body.

2. The mobile object according to claim 1, wherein the moving means each include a motor provided in the foot frame and a wheel driven by the motor.

3. The mobile object according to claim 1, wherein the telescopic actuators each include a position detector.

4. The mobile object according to claim 1, wherein the sensor detects a lateral tilt angle and an angular velocity of the body with respect to the direction of gravity.

5. The mobile object according to claim 1, wherein the controller calculates a sum of a product of a difference between the lateral tilt angle and a lateral tilt angle target value and a predetermined positional gain and a product of a difference between the angular velocity and an angular velocity target value and a predetermined velocity gain, the sum being used as a control command value.

6. The mobile object according to claim 1, wherein the controller outputs the control command value to the rotary actuator.
